(19) United States
(12) Patent Application Publication
(10) Pub. No.: US 2017/0247121 A1
(43) Pub. Date: Aug. 31, 2017

(54) Unknown

(71) Applicant: Airbus Operations SAS, Toulouse (FR)

(72) Inventor: Bernard Guering, Montrabe (FR)

(21) Appl. No.: 15/442,129

(22) Filed: Feb. 24, 2017

(30) Foreign Application Priority Data
Feb. 25, 2016 (FR) 1651562
Apr. 5, 2016 (FR) 1653002

(51) Int. Cl. B64F 5/10; B66C 13/18; B66C 19/00; B64C 1/18

(52) U.S. Cl. CPC B64F 5/10; B64C 1/18; B66C 13/18; B66C 19/00

(57) ABSTRACT

A tooling making it possible to mount a module directly in an aircraft without making any modifications to the module. This tooling is made up of upper beams connected to the structure of the aircraft, lower beams secured to the module, lift elements connecting the lower beams to the upper beams and a drive system. The lift elements can move along the upper beams. The drive system makes it possible to convey the module to its functional location in the aircraft, by moving it along the upper beams via the lift elements. The principle of this tooling is to suspend the module in order to ensure and control its movement in the aircraft.

### CROSS-REFERENCES TO RELATED APPLICATIONS

This application claims the benefit of the French patent application No. 1651562 filed on Feb. 25, 2016 and of the French patent application No. 1653002 filed on Apr. 5, 2016, the entire disclosures of which are incorporated herein by way of reference.

### FIELD OF THE INVENTION

The invention relates to tooling for integrating a module into an aircraft and an associated integration method. In general, a module consists of a functional or nonfunctional block that is bulky, fragile and not sufficiently rigid, that is able to be positioned, as is, in a confined space of the aircraft, without having been subject to prior disassembly. This module may for example be made up of a front module intended to be placed at the nose of an aircraft, the module, in particular, comprising seats, benches, a large portion of the system installations including electricity, air and oxygen sources, as well as a piece of cockpit equipment related to a floor of the cockpit.

### BACKGROUND OF THE INVENTION

Currently, the improvements made to an aircraft, in particular those regarding the cockpit, are done using several successive operations each related to a particular element and/or a very localized zone of the aircraft, each of the operations being done with specific tooling. Furthermore, these operations are often done in confined spaces, requiring an operator to engage in complicated and restrictive manipulations, which may slow the installation process for these improvements. Such an assembly configuration also results in the improvements mobilizing a large number of operators.

### SUMMARY OF THE INVENTION

One aim of the invention is to allow improvements to be made to an aircraft quickly and easily, in particular during the integration phase, while eliminating at least some of the drawbacks encountered in the state of the art.

The invention relates to tooling for installing a module in a structure of an aircraft. According to the invention, the tooling comprises:

at least two lower beams intended to be secured to the module,

at least two upper beams intended to be secured to the structure of the aircraft, for example to an upper and inner zone of the structure of the aircraft,
lift elements connecting the upper beams to the lower beams, each lift element having a variable length and being provided with an adjustment device specific to its length.

The principle of such tooling is to suspend a functional or nonfunctional module in the aircraft from upper beams, in order to move it along the upper beams and convey it toward a specific zone of the aircraft intended to receive the module. Managing the length of each lift element specifically (independently of managing the length of the other lift elements), in particular, makes it possible to give the module fastened to the tooling different spatial orientations, and in particular, different trajectories inside the aircraft during its movement. It is assumed that the module can form a functional block that is ready to use as is, and that has not undergone any structural modification, such as total or partial disassembly, during its mounting phase in the aircraft. The module can alternatively form a nonfunctional block, in the sense that functional elements (for example cables, conduits, etc.) are missing from the module for it to be operational within the aircraft once it is installed. These functional elements are, for example, added to the module once it has been installed in the aircraft. The functional or nonfunctional module may comprise, in general, a set of elements or pieces of equipment physically (mechanically) connected to one another by one or several shared elements (e.g., a floor) and that forms a unified mechanical assembly or module that can be transported in one piece.

A module able to be installed by a tooling can, for example, comprise an aircraft floor that, for example, comprises a grid structure formed by interlacing crosspieces parallel to one another and longitudinal elements (e.g., rails) parallel to one another and fastened to the crosspieces. Such a floor forms a unified module that is configured to be transported in one piece to the inside of the aircraft nose. The grid structure of the floor may or may not integrate cables and/or conduits (more generally, system circuits) that are fastened to the structure and are part of the unified module configured to be transported in one piece (pre-equipped floor, i.e., functional, or non-pre-equipped floor, i.e., nonfunctional).

A module able to be installed by a tooling can, for example, comprise:
only the pre-equipped or non-pre-equipped floor as defined above; or
the pre-equipped or non-pre-equipped floor, as well as additional pieces of equipment, such as one or several avionics systems, and/or one or several seats, and/or one or several pieces of furniture, and/or one or several navigation instruments, and/or a dashboard, and/or one or several wall/partition or door elements, etc.; the pre-equipped or non-pre-equipped module comprising a floor and additional pieces of equipment can thus be a front module or a cockpit module and that, for example, comprises the component elements of a cockpit (seats, dashboard and navigation instruments, avionics systems, and optionally pieces of furniture, benches and wall and/or door element(s)) and that are situated above the cockpit floor. This module may also integrate electrical and/or fluid equipment/systems connected to the cockpit floor and that are situated below the floor.

Alternatively, the module may not include a floor, but only one or several pieces of equipment, such as one or several of the additional pieces of equipment above, and which form a unified mechanical assembly or module that can be transported in one piece.

Due to the large dimensions of the module (generally bulky module), the lower beams serve as stiffeners for the module so that it does not deform during the different handling and transport phases in the aircraft. They also serve as anchoring points for the module in order to be attached to the upper beams. The tooling is temporary for the time needed to mount the module in the aircraft, and it is next completely removed once the module has been placed in position, and all of the operations to fasten the module on the airplane have been carried out in the aircraft. It should be specified that the tooling may comprise more than two upper beams and more than two lower beams. The lift elements may, for example, be made up of wires, cables, ropes, chains or cords.

According to one possible feature, each element is movably connected to an upper beam so as to be able to move freely along the upper beam, and is fixedly connected to a lower beam.

According to one possible feature, the tooling comprises a drive system able to move the lift elements along the upper beams, and therefore the module intended to be attached to the lower beams.

According to one possible feature, the two upper beams are parallel and extend along a longitudinal axis that is a longitudinal axis of the aircraft when the tooling is fastened to the structure of the aircraft.

According to one possible feature, the two upper beams each have a profile that is intended to adapt to the profile of the upper and inner zone of the structure of the aircraft.

According to one possible feature, the two upper beams are each rectilinear over a first part and curved over a second part. This shape of the tooling, for example, makes it possible to install a floor in the nose of an aircraft or in the tail. Such a floor, for example, comprises the structure described above and is pre-equipped or non-pre-equipped.

According to one possible feature, the two lower beams are parallel to one another and are parallel to the upper beams, each upper beam being placed aligned with a lower beam.

According to one possible feature, each lift element is vertical and connects an upper beam to a lower beam that is aligned with the upper beam.

According to one possible feature, the two lower beams are intended to be fastened to the module, for example to rails of the module, with fastening means, for example quick fastening means.

According to one possible feature, each connection between a lower beam and the module, for example the rail of the module, allows the beam to rotate around its longitudinal axis.

According to one possible feature, the two upper beams are intended to be fastened to frames of the structure of the aircraft with fastening means, for example quick fastening means.

According to one possible feature, each connection between the upper beam and the frames allows a rotation of the beam around its longitudinal axis.

According to one possible feature, each lift element is connected to at least one roller mounted on the upper beam and able to roll along the beam. A drive system of the tooling makes it possible to set the rollers in motion along the upper beams in order to move a module such as a pre-equipped or non-pre-equipped floor, as described above. The tooling can include a command and control device to ensure optimized movement of the floor along the upper beams. The length of the lift elements may, in particular, be readjusted at each moment during the movement of the floor along the upper beams.

According to one possible feature, each lift element has a variable length and is provided with a device for adjusting to its length.

According to one possible feature, the tooling comprises a command and control device making it possible to control, in real time and in synchronization, all of the devices for adjusting the length of the lift elements.

According to one possible feature, the device for adjusting the length of each wire is provided by a slaved electrical screw/nut system.

According to one possible feature, the command and control device is able to cause the module to undergo at least one movement to be chosen from among a rotation around a longitudinal axis of the aircraft, a rotation around a transverse axis of the aircraft and a translational movement along a vertical axis. The command and control device can also cause the module to undergo a combination of at least two of the movements.

According to one possible feature, two successive lift elements along a same upper beam are separated by mechanical means ensuring a constant distance between the two elements at the upper beam.

According to one possible feature, the drive system is produced by two traction ropes driven by an electric winding/unwinding device, the ropes cooperating with an upper end of at least one lift element. In this way, the driving device acts either directly on the upper end of at least one lift element, or on a moving part to which the upper end is secured, the part, for example, being able to be a roller or a carriage.

According to one possible feature, the lower beams are able to stiffen the module.

According to one possible feature, the tooling comprises a system for detecting obstacles, the information provided by this detection system dictating the spatial orientation of the module as well as the characteristics of the movement in the aircraft via the lift elements.

According to one possible feature, the tooling comprises shim stops secured to frames of the structure of the aircraft, the shim stops being intended to support the module at certain crosspieces of the module and therefore to freeze its module altitude in the aircraft.

According to one possible feature, each lift element is a wire.

According to one possible feature, the tooling comprises a number of lift elements that is suitable for mechanically stiffening the module when it is fastened to the tooling.

The invention also relates to an aircraft that comprises a tooling for installing a module as briefly described above (the tooling may only be present during the integration phase or part of the tooling may remain permanently, such as the upper beams, depending on the acceptable weight constraints). The term “aircraft” may comprise an aircraft part, such as a nose, a central part or a tail.

The invention also relates to a method for integrating a module into an aircraft using tooling as briefly described above. According to the invention, the method comprises the following steps:

a step for securing two upper beams to an upper and inner zone of the structure of the aircraft,

a step for securing two lower beams to the module, for example on two rails of the module,

a step for inserting the module into the aircraft,

a step for fastening the lift elements of the lower beams and the upper beams, such that each lift element connects an upper beam to a lower beam,

a step for moving the module along the upper beams to convey it to a specific receiving zone of the aircraft. The movement step may comprise a step for actuating the drive system, as briefly described above.

### BRIEF DESCRIPTION OF THE DRAWINGS

Below, a detailed description is provided of one possible alternative of a tooling according to the invention, in reference to the following figures:

FIG. 1A is a simplified side view of an aircraft showing a module in the mounting phase according to one embodiment of the invention;

FIG. 1B is a simplified side view of the aircraft of FIG. 1A showing the module mounted in its final position,

FIG. 2A is a perspective view of the inside of an aircraft showing a module in the mounting phase and an installation tooling according to one embodiment of the invention,

FIG. 2B is a perspective view of the inside of the aircraft of FIG. 2A showing the module mounted in its final position,

FIG. 3 is a perspective view of the inside of the aircraft of FIGS. 2A and 2B, and in which the module has been artificially removed,

FIG. 4 is a perspective view of the main elements making up a tooling according to one embodiment of the invention, as they appear when the tooling is mounted in an aircraft,

FIG. 5 is a side view of the tooling of FIG. 4,

FIG. 6 is an enlarged perspective view of part of a tooling according to one embodiment of the invention, mounted in an aircraft,

FIG. 7A is a simplified side view of an aircraft showing a first possible rotation of a module owing to a tooling according to one embodiment of the invention,

FIG. 7B is a simplified front view of an aircraft showing a second possible rotation of the module owing to a tooling according to one embodiment of the invention,

FIG. 8 is a simplified perspective view of an aircraft nose in which a tooling is installed for implanting a module according to one embodiment of the invention,

FIG. 9 is a general schematic perspective top view of a unified floor structure of an aircraft nose according to one embodiment of the invention,

FIG. 10 is a partial schematic perspective top view of the floor structure of FIG. 9,

FIG. 11 is a partial schematic longitudinal sectional view in plane XZ of the floor structure of FIG. 10 equipped with various sets of cables and/or system circuits,

FIG. 12 is a perspective view of the inside of the nose from the rear end thereof, with a tooling installed,

FIG. 13 is a schematic perspective view of the nose during integration of the unified floor of FIG. 9,

FIG. 14 is a perspective top view of the inside of the nose from the rear end thereof with the unified floor of FIG. 9 installed,

FIG. 15 is a schematic view showing possible systems for controlling the length of the lift elements.

### DETAILED DESCRIPTION OF THE PREFERRED EMBODIMENTS

The detailed description of the embodiment that follows is focused on an installation tooling 10 developed for integrating a module 1 in a nose 2 of an aircraft 3 and an associated installation method. It should be specified that all or some the features of this tooling 10 could be copied for integrating any other module into the aircraft 3. Another module could thus be installed in the same location (cockpit zone) or elsewhere in the aircraft.

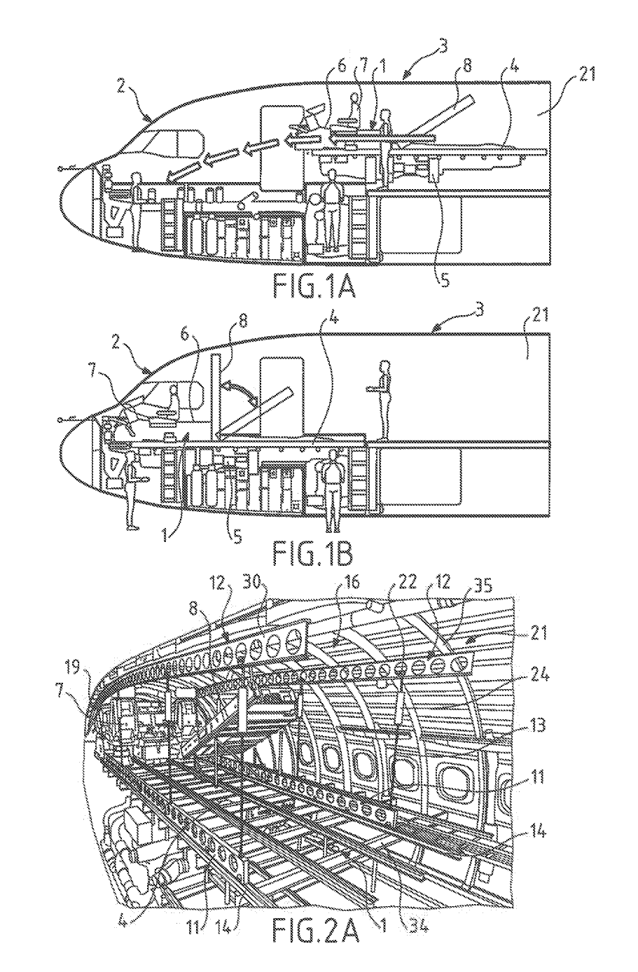

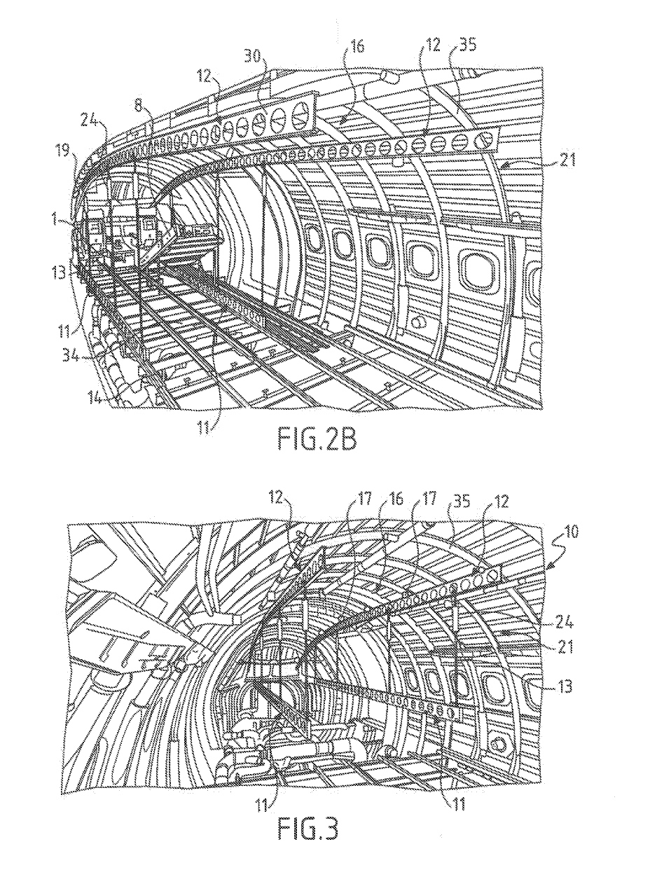

In reference to FIGS. 1A, 1B, 2A and 2B, such a front module 1, for example, schematically comprises three zones 4, 5, 6, broken down into a floor zone 4, a lower zone 5 and an upper zone 6, the floor zone 4 separating the upper zone 6 from the lower zone 5. The lower zone 5, for example, comprises terminal boxes, various wiring, gas canisters, computers, etc. The upper zone 6, for example, comprises seats 7, side seat banks, a rotating rear wall 8 (inclined wall able to be raised into a vertical position once the module is installed, as shown in FIG. 1B), anti-torque pedals, etc. The floor zone 4 is planar and thin, and is, for example, formed by an aluminum structure. This floor zone 4 could also be made up of a structure made from a composite material, for example carbon. This module 1 is elongated, and its longitudinal axis is parallel to the longitudinal axis of the aircraft 3 in which it will be mounted. Such a module 1 is cumbersome, bulky and somewhat fragile. It is also heavy, typically weighing several hundred kilograms. The module described here is functional in the sense that it is ready for use as is (subject to performing several electrical, and potentially fluid, connections to the structure and/or to the equipment or systems existing in the aircraft before placement of the module) in the cockpit. According to one alternative that is not shown, the module is nonfunctional, i.e., it is not ready for use as is, and in order to be operational, requires the addition of elements or functional equipment/systems (e.g., cables, fluid conduits, avionics systems such as computers, instruments, avionics furniture, etc.). These elements or equipment/systems are added after placement of the bulky and heavy module. Even if all of the elements or equipment/systems allowing the module to be functional are present in the module when it is installed, building the module outside the aircraft and installing it in the aircraft in a single operation, in its final location (where it will perform its functionalities) are made much easier owing to the aforementioned tooling, which will be described in more detail below.

When this module 1 is integrated into the nose 2 of the aircraft 3, specific installation tooling 10 according to one embodiment of the invention is implemented in the aircraft 3 to convey the module 1 toward its final installation site in the aircraft 3. It must be specified that the module 1 is integrated into the aircraft 3 as is, without undergoing the slightest structural modification beforehand, for example complete or partial disassembly. Furthermore, this tooling 10 is temporary, for the time needed to install the module 1 in the aircraft 3. It is removed immediately after the module 1 is installed, once all of the fastening operations of the module 1 have been performed.

In reference to FIGS. 2A, 2B, 3, 4, 5 and 6, this tooling 10 primarily comprises two lower beams 11, two upper beams 12, lift elements 13, such as wires, connecting the lower beams to the upper beams situated over it. The tooling system 10 may also comprise, as described later, a drive system, a command and control system, and optionally, an obstacle detection system.

The lower beams 11 are, for example, rectilinear and are fastened to longitudinal elements 14 such as rails 14 of the floor zone 4 of the module 1, so as to emerge toward the top of an upper surface of the floor zone 4 comprising the rails 14. This floor zone 4 comprises at least two parallel and longitudinal rails 14, each lower beam 11 being fastened to one of the rails 14, for example via quick fastening means, similar to those used to fasten cabin seats. The floor zone 4 of the module 1 also comprises a certain number of crosspieces 34 extending perpendicular to the rails 14. These lower beams 11 have a degree of rotational freedom around a longitudinal axis of the rail 14, so as to be able to move and avoid excessive stressing of the rails 14 on the module 1 during various manipulations. The lower beams 11 are, for example, planar and thin. They, for example, have a certain number of perforations 15 over their length, so as to limit their weight and allow them to be connected with the rails 14. These beams 11 are fastened to the rails 14 so as to fit into a vertical and longitudinal plane of the module 1 and emerge in the upper part of the floor zone 4.

In reference to FIGS. 2A, 2B, 3, 4 and 5, the upper beams 12 each have a first rectilinear (non-curved) part 30 extended by a second curved front part 19, and are fastened to a structure 21 of the aircraft 3. The structure 21 of the aircraft 3 traditionally comprises frames 35 in the form of rings, and a ceiling 16 extending longitudinally in the aircraft 3. The upper beams 12 are fastened to the frames 35 at the ceiling 16, via quick fastening means 17, for example fasteners of the shackle type. Removable flanges on the frames 35 may advantageously provide an articulated connection of the upper beams 12 on the frames 35. The two upper beams 12 are parallel and extend along a longitudinal axis of the aircraft 3. The upper beams 12 are, for example, planar and thin. They, for example, have a certain number of perforations 18 over their length, so as to limit their weight. They are fastened to the frame 35, so as to fit into a vertical and longitudinal plane of the module 1, and emerge downward from the frames 35. In general, the profile of the upper beams 12 is dictated by the profile of the zone of the structure 21 of the aircraft 3 to which they are fastened. Thus, the front part 19 of each upper beam 12 is curved downward, so as to respect the profile of the nose 2 of the aircraft 3, such that the front end 20 of the front part 19 is at a lower altitude than that of the non-curved part 30 of the upper beam 12. The separation of the two upper beams 12 is identical to that of the two lower beams 11.

An integration method according to one embodiment of the invention comprises a prior step for inserting the module 1 into the structure 21 of the aircraft 3, such that the upper beams 12 are parallel to the lower beams 11, each upper beam 12 being aligned with a lower beam 11. In other words, each upper beam 12 fits with the lower beam 11 aligned with the latter, in a vertical and longitudinal plane of the aircraft 3.

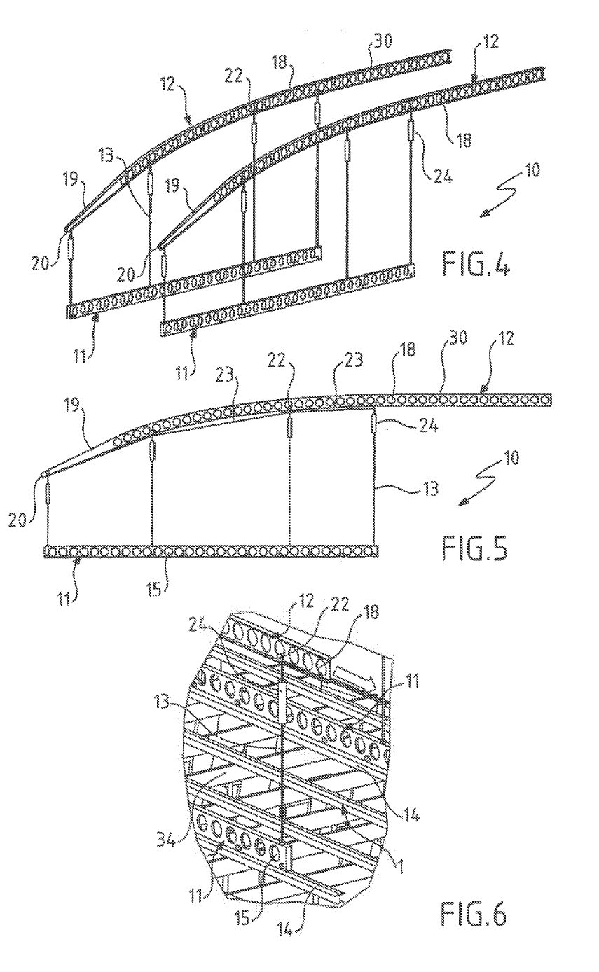

In reference to FIGS. 4, 5 and 6, the lifting wires 13 each connect a lower beam 11 to the upper beam 12 aligned with the lower beam 11. All of the lifting wires 13 are parallel, and therefore extend in a substantially vertical direction. These wires 13 are fixedly secured to the lower beam 11, such that they cannot move along the lower beam 11. Conversely, they are movably secured to the upper beam 12, to allow them to move along the upper beam 12 (relative movement possible between each wire and the upper beam to which it is attached).

To that end, each wire 13 is connected to the upper beam 12, for example via at least one roller 22 suitable for rolling along the upper beam 12 on which it is placed. In this way, a movement of these rollers 22 along the upper beams 12 via the aforementioned drive system (e.g., motorized system) will drive a movement of the wires 13, which, in turn, will create the movement of the module 1 to which they are fixedly connected via the lower beams 11. Indeed, in order to offset the pulling forces exerted on the wires 13, the lower end of each wire 13 will move in the same direction as that of the upper ends connected to the rollers 22. These rollers 22 will contribute to allowing the module 1 to move along the upper beams 12.

In reference to FIGS. 4, 5 and 6, each lifting wire 13 has a variable length and, for example, has its own device 24 for adjusting its length (this independent adjusting device for managing the length of each wire makes it possible to adapt to inner zones of the aircraft having an evolving geometry). All of the adjusting devices 24 are controlled in real time and in synchronization by the aforementioned command and control system, using a central computer, so as to ensure the module 1 movement in the aircraft 3 under optimal conditions, while, in particular, avoiding potential obstacles that may block the passage of the module 1 (owing to the aforementioned optional obstacle detection system). The length of each wire 13 is thus controlled, while being monitored and corrected at each moment throughout the method for integrating the module 1 into the aircraft 3. The command and control system will make it possible to adjust the altitude of the module 1 in the aircraft 3, or even of certain parts of the module, for example the front, the back and/or one of the sides of the module. This makes it possible to give the module a particular spatial orientation, for example adapted to the internal environment of the aircraft. One possible adjusting device 24, for example, comprises a slaved electrical screw/nut system.

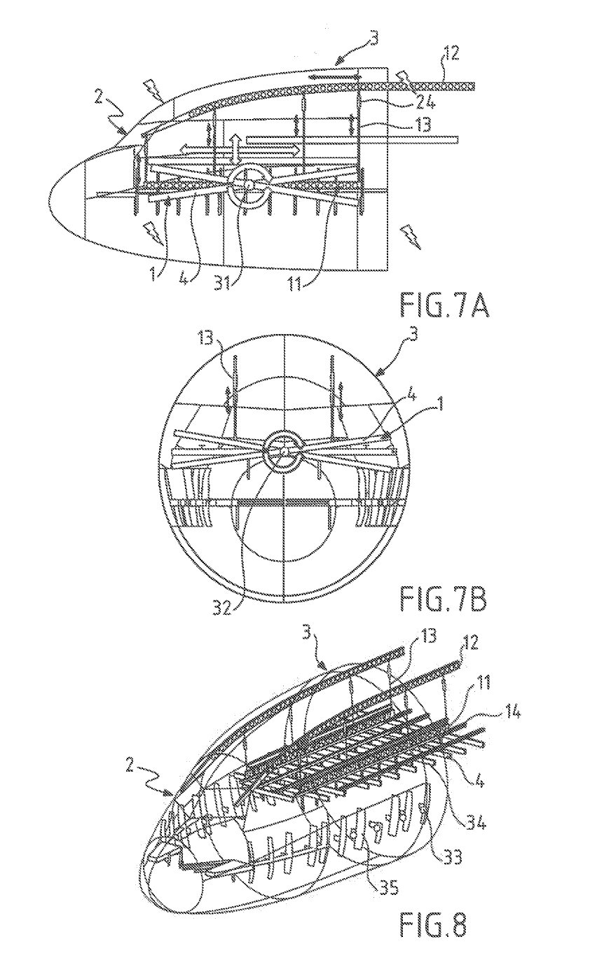

In reference to FIG. 7A, owing to the configurability of the length of each wire 13, the command and control system also makes it possible to cause the module 1 to undergo a first type of rotation around a transverse axis 31 of the aircraft. In this way, the module 1 can tilt, either by raising its front part or lowering its rear part, or the reverse. Upon undergoing such tilting, the module 1 performs a partial pitch movement.

In reference to FIG. 7B, the command and control system makes it possible to cause the module 1 to undergo a second type of rotation around a transverse axis 32 of the aircraft 3. By performing such a rotation, the module 1 performs a partial roll movement.

It should be noted that the module 1 can be moved in the aircraft 3 by combining the two preceding rotational movements, i.e., one around a longitudinal axis 32 of the aircraft 3 and the other around a transverse axis 31 of the aircraft. It will be noted that one and/or the other of the aforementioned rotational movements can be considered when the module moves forward or backward in the aircraft or when the module is stopped.

The presence of wires 13 with an individually adjustable length makes it possible to cause the module 1 suspended in the aircraft 3 to undergo multiple movements so as to adjust its spatial orientation and increase the quality of its movement, for example and, in particular, by taking into account the presence of certain potential obstacles.

In reference to FIG. 5, a tooling 10 according to one embodiment of the invention may also comprise mechanical separators 23 making it possible to keep a constant distance between two successive wires 13, at their movable upper ends fastened to the rollers 22. In this way, the distance separating two successive wires 13 at an upper beam 12 is constant during the entire movement phase of the module 1 along the upper beams 12 (forward or backward).

The drive system is produced using two traction ropes, not shown in the figures, and driven by an electric winding/unwinding device. These traction ropes are connected to at least one roller 22 so as to cause the roller 22 to move along the upper beam 12 on which it is placed. Setting this roller 22 in motion will cause the other rollers 22 and the wires 13 that are connected to the rollers 22 to move. The movement of these wires 13 will automatically cause the movement of the module 1 that is connected to these wires 13 via the lower beams 11.

The command and control system is provided using a central computer to ensure an adjustment to the length of the set of lifting wires 13.

The obstacle detection system, based on recognition of the environment (existing internal structure of the aircraft and equipment existing before placement of the module) and the real-time position of each controlled element relative to this environment, is associated with the command and control system. Indeed, the length of each wire 13 is adjusted in real time based on information from the obstacle detection system, so as to position the module 1 correctly in space, so that it avoids the potential obstacles on its route.

In reference to FIG. 8, the tooling 10 can also comprise temporary stops 33 intended to support the module 1, once it has reached its functional location in the aircraft 3 (shim stops). Indeed, the crosspieces 34 of the floor zone 4 of the module 1 are made to come into contact with the frames 35 of the structure 21 of the aircraft 3. These stops 33 are therefore secured to the frames 35 and the module 1 is placed on these stops 33, which make it possible to block the module 1 in a vertical direction. In FIG. 8, only the floor zone 4 of the module 1 has been shown for simplification reasons.

An integration method according to one embodiment of the invention, and making it possible to install the module 1 in the nose 2 of the aircraft 3 with a tooling 10 according to one embodiment of the invention, comprises the following steps:

a step for securing the two upper beams 12 to the frames 35 of the structure 21 of the aircraft 3, for example with quick fastening means 17,

a step for securing the two lower beams 11 on two rails 14 of the floor zone 4 of the module 1,

a step for inserting the module 1 into the aircraft 3, such that the lower beams 11 are parallel to the upper beams 12, each upper beam 12 being aligned with a lower beam 11 of the module 1,
a step for fastening lifting wires 13 to the lower beams 11 and the upper beams 12 (the fastening order can be reversed), each wire 13 connecting an upper beam 12 to the lower beam 11 situated aligned with the upper beam 12; the fastening of each wire 13 at the upper beam 12 is done via at least one roller 22 and via mechanical separators 23 positioned between the rollers; this fastening step is intended to suspend the module 1 from the two upper beams 12, since there is no support in the structure 21 of the aircraft 3 able to support the module 1; each wire 13 is fixedly connected to a lower beam 11,

a step for installing stops 33 on the frames 35 of the structure 21 of the aircraft 3 (this step can be done before),

a step for actuating a drive system to set the rollers 22 in motion along the upper beams 12 and move the module 1 along the upper beams 12 via lifting wires 13 connected to the lower beams 11 secured to the module 1,

a step for actuating the command and control system and, for example, the obstacle detection system, to ensure optimized movement of the module 1 along the upper beams 12, in particular with a readjustment of the length of each wire 13 at each moment of the movement of the module 1 along the upper beams 12,

a step for moving the module 1 toward the front of the aircraft 3 (toward the front end of the aircraft), this movement comprising a first horizontal component performed along non-curved parts 30 of the upper beams 12 at a constant altitude, followed by an oblique component along curved front parts 19 of the beams 12, allowing gradual lowering of the module 1 in order to place it as precisely as possible in the nose 2 of the aircraft 3, in a final operational position,

a step for depositing the module 1 on the stops 33,

a step for complete fastening of the module 1 in a functional position in the aircraft 3,

a step for removing the tooling 10 made up of the upper beams 12, the lower beams 11, the lifting wires 13, the stops 33, the actuating system, the command and control system, and, for example, the obstacle detection system, once all of the operations to fasten the module 1 in the aircraft 3 have been performed.

It will be noted that the order of some of the above steps may be reversed, and, for example, the lower beams may be fastened to the module after the module is inserted into the aircraft.

An installation tooling 10 according to one embodiment of the invention in particular has the following advantages:
It allows a functional or nonfunctional module 1 to be mounted directly in the appropriate location of the aircraft 3, without having to make any modifications to the module 1. In other words, it is not necessary to completely or partially disassemble the module 1 or package it in a very specific way, to install it in the aircraft 3.
It makes it possible to carry out a quick and easy method for installing the module, while preventing the method from multiplying tedious steps requiring precision and complicated manipulations.
It prevents the operators present in the aircraft 3 to mount the front module 1 from being in confined and remote locations, which would force them to perform difficult contortions and uncomfortable manipulations.
It implements parts having a simple geometry, for example the lower 11 and upper 12 beams, which are easy to machine and are made from a standard material.
It can be assembled and disassembled quickly and easily, without having to alter the structure 21 of the aircraft 3 or the module 1, thus preserving the integrity of the structure 21 and the module 1.
It mobilizes a limited number of operators.
It saves considerable time by making it possible to install a bulky assembly very quickly and in one piece. This results in increased airplane production rhythms, owing to the limited time per production phase, and without having to multiply assembly sites.

It will be noted that at least some of the aforementioned advantages can be obtained with a tooling that does not necessarily include all of the features set out above relative to FIGS. 1 to 8, but only some of them.

The preceding description was done using the example of lift elements 13 of the lifting wires. However, according to alternatives that are not shown, other lift elements 13 such as cables, ropes, chains, cords, etc. can be used in place of the wires, and the preceding description applies to lift elements in general.

According to one alternative, not shown, each lift element is movably connected to an upper beam via one or several other members performing the same function as a roller.

It will be noted that the tooling intended to install a module in an aircraft can be fastened to elements other than rails of the module, irrespective of whether the module comprises rails.

In general, a tooling including at least two upper beams, at least two lower beams and lift elements connecting each lower beam to the upper beam situated over it may be used to install a module in another location of the aircraft. The upper beams, for example, each have a profile that is intended to adapt to the local profile of the upper and inner zone of the structure of the aircraft where the beams will be installed. Thus, for example, the upper beams (as well as the lower beams) are only rectilinear (i.e., not including a curved part as in the figures previously described), since they are placed in a zone of the aircraft having a constant geometry (non-evolving zone). The sets of lower and upper beams parallel to one another are, for example, used to install all or part of a cabin floor of the aircraft. Such a tooling may also include some of the features set out above relative to FIGS. 1 to 8 (e.g., lift element fixedly connected to a lower beam and movably connected to an upper beam, drive system and/or command and control device and/or adjusting device and/or mechanical separating means, etc.) or all of the features described above relative to FIGS. 1 to 8, with the exception, however, of the curved part of the upper beams.

A tooling with upper beams having a curved part, the other part being rectilinear, for example like that of FIGS. 1 to 8, can be used to install a module in a tail of an aircraft but also has an evolving geometry similar to that of the nose. Such a tooling may also include some of the features set out above relative to FIGS. 1 to 8 (e.g., lift element fixedly connected to a lower beam and movably connected to an upper beam, drive system and/or command and control device and/or adjusting device and/or mechanical separating means, etc.) or all of the features described above relative to FIGS. 1 to 8.

In general, a tooling including at least two upper beams, at least two lower beams and lift elements connecting each lower beam to the upper beam and each provided with a specific device for adjusting the length of each element has a particularly simple design, installation and operation. Such a tooling does not require other intermediate parts to fasten lift elements to the module or for fastening to the beams, or even for fastening to the inner structure of the aircraft.

Any one of the toolings described above, whether in its general form, with upper beams having a curved part, the other part being rectilinear, for example like that of FIGS. 1 to 8, or with completely straight upper beams, can be used to install a module comprising an aircraft floor. The aircraft floor, for example, comprises a grid structure formed by interlacing crosspieces parallel to one another and longitudinal elements (e.g., rails) parallel to one another and fastened to the crosspieces. Such a floor forms a unified module that is configured to be transported in one piece to the inside of the aircraft nose. The grid structure of the floor may or may not integrate cables and/or conduits or system circuits that are fastened to the structure and are part of the unified module configured to be transported in one piece (pre-equipped floor, i.e., functional, or non-pre-equipped floor, i.e., nonfunctional).

A module to be transported by such a tooling can, for example, comprise:
only the pre-equipped or non-pre-equipped floor; or
the pre-equipped or non-pre-equipped floor, as well as additional pieces of equipment, such as one or several avionics systems, and/or one or several seats, and/or one or several pieces of furniture, and/or one or several navigation instruments, and/or a dashboard, and/or one or several wall/partition or door elements, etc.; the additional elements can be situated above and/or below the floor and connected thereto.

Alternatively, the module may not include a floor, but only one or several pieces of equipment such as one or several of the additional pieces of equipment set out above, or even others.

In general, a module able to be installed using such a tooling may comprise, in general, a set of elements or pieces of equipment physically (mechanically) connected to one another by one or several shared elements (e.g., a floor) and that forms a unified mechanical assembly or module that can be transported in one piece. When the assembly is reduced to a floor, the floor itself forms the mechanical module, which is sufficiently mechanically connected or rigid to be able to be transported in one piece.

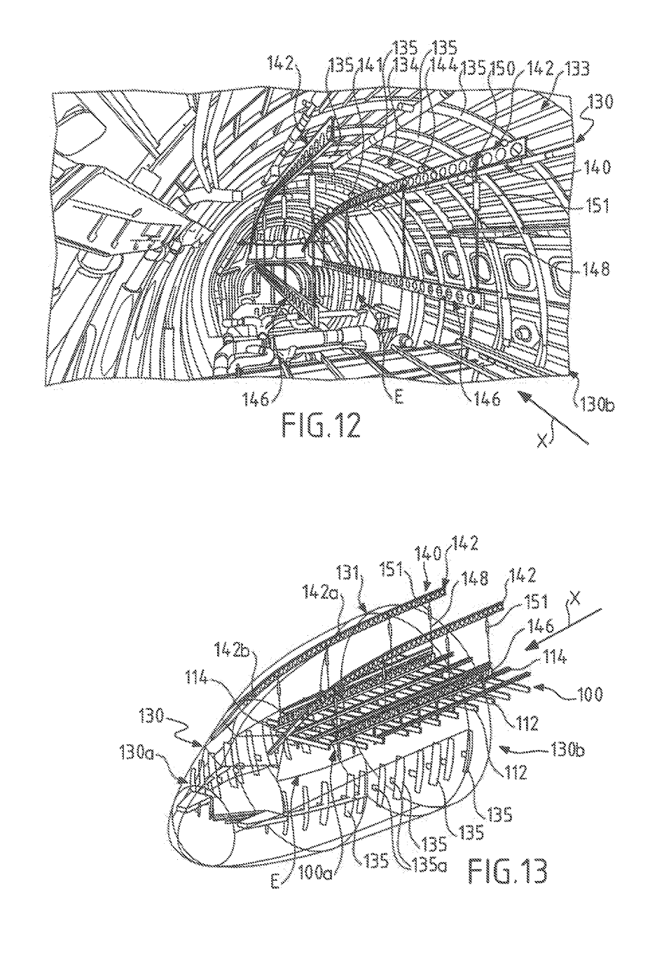

The advantages set out above regarding the tooling described in reference to FIGS. 1 to 8 also apply to the other alternatives of toolings described above as well as the tooling described in reference to FIGS. 12 to 14.

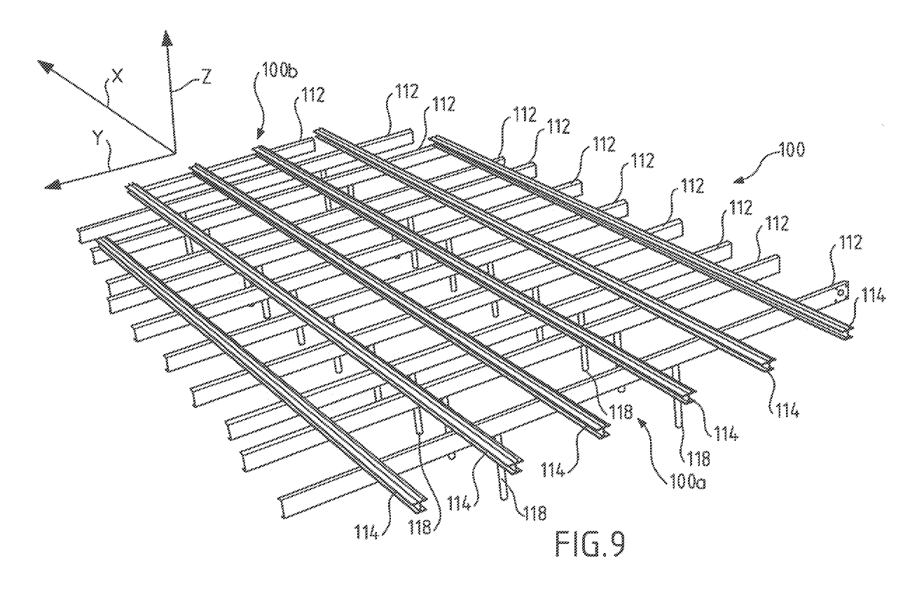

In reference to FIGS. 9 to 14, we will now describe an aircraft nose floor according to one embodiment of the invention and a tooling for installing the floor in an aircraft nose, as well as an associated method.

As shown in FIG. 9 and designated by general reference 100, an aircraft nose floor according to one embodiment of the invention comprises:
a plurality of parallel crosspieces 112, positioned in a same plane, and
a plurality of parallel longitudinal elements 114, positioned in a same plane and fastened to the crosspieces 112. The crosspieces 112 intersect the longitudinal elements 114 so as to form a single-piece (module) or unified grid structure that can be moved in one piece. In the example embodiment shown in FIG. 9, at least most of the crosspieces 112 are spaced regularly apart from one another, and the same is, for example, true for the longitudinal elements 114.

The longitudinal elements 114 are structural elements that are, for example, rails. In the rest of the description, the longitudinal elements will be called rails, but the rest of the description applies generally to any longitudinal element able to form a single-piece (module) or unified interlacing structure with the crosspieces.

The rails 114 will be positioned in the direct extension of the rails of the aircraft cabin when the floor has been installed in its final functional position.

The rails 114 are, for example, positioned above the crosspieces 112.

The floor 100 of FIG. 9 (crossed network of crosspieces and rails) is thus permanently assembled outside the nose of an aircraft. The floor behaves like a module or unified assembly that can be moved in one piece to be installed in an aircraft nose. The floor as described above can be installed as is (non-pre-equipped floor) in the nose of an aircraft with the tooling that will be described later or with one of the toolings described above.

In the example embodiment, the floor nevertheless behaves like a module or unified assembly base inasmuch as its grid can, in particular, accommodate sets of cables and/or other system circuits (such as oxygen conduits), as will be seen later. Everything that is described below for the cables applies to any other type of system circuit (a system circuit is a connecting element between systems internal to the aircraft and that conveys electricity or a fluid, for example to power a system or transport data), such as a conduit conveying a fluid (e.g., oxygen).

As shown in FIG. 9, the interlacing 100 (floor) of crosspieces 112 and rails 114 has an elongated general shape along a longitudinal axis X. This axis X will be combined with the longitudinal axis of the aircraft nose when the floor 100 is installed in the nose. The rails 114 are parallel to the longitudinal axis X. The floor 100 has a width that is dictated by the length of the crosspieces 112, and a length dictated by the length of the rails 114. The width of the crosspieces 112 is substantially constant over the majority of the longitudinal dimension of the floor (at least ⅔ of the longitudinal dimension) from the rear end 100a toward the front end 100b. The width of the crosspieces 112 becomes smaller near the front end 100b (in top view) so as to adapt to the reduced cross-section of the aircraft at the front end of the nose (evolving geometry). In other words, the crosspieces have an evolving length due to the evolving shape of at least part of the aircraft noses.

The floor 100 also extends along another dimension or height considered along the vertical axis Z that is perpendicular to the extension directions X of the rails 114 and Y of the crosspieces 112. The height of the floor structure 100 is globally dictated by the cumulative height of the crosspieces 112 and the rails 114.

The grid floor structure 100 can incorporate a plurality of sets of cables and/or other system circuits (such as oxygen conduits or pipes, etc.) that are already fastened to the structure before placement of the latter in the nose of an aircraft.

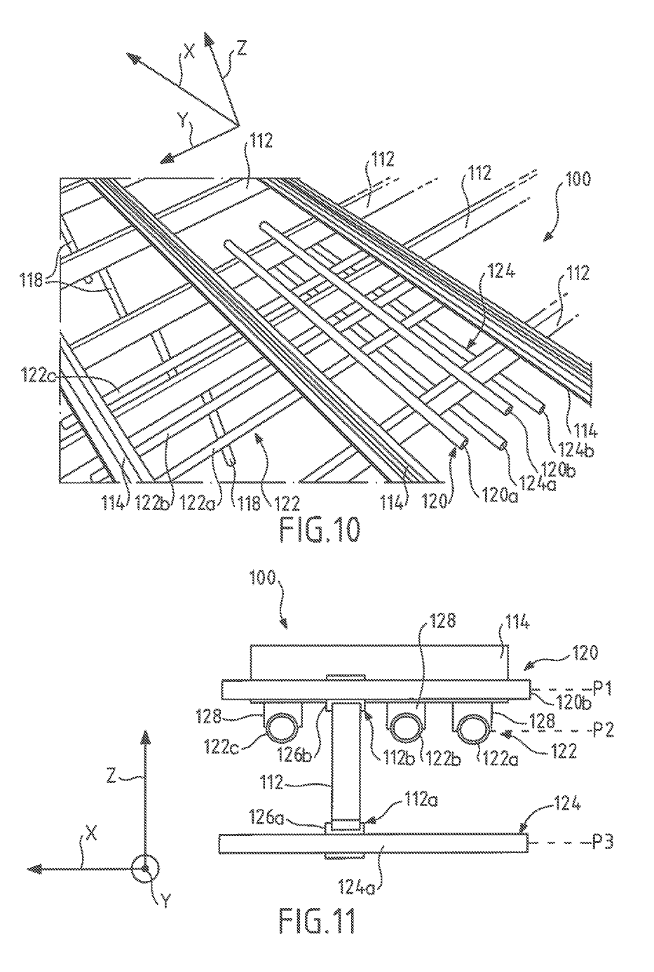

FIG. 10 is a partial schematic perspective top view of the structure 100 of FIG. 9 incorporating several separate sets of electrical cables and/or other system circuits, for example only three of which, denoted 120, 122, 124, are shown for clarity reasons. The number of separate sets of cables fastened to the structure 100 may, however, be different, and, in particular, higher. FIG. 10 shows sets of cables (this may alternatively involve conduits, or cables and conduits). These separate sets of cables are each situated in a different geometric zone relative to the structure. All or some of these sets may be situated in a zone of the structure and/or outside it (for example above, below, next to the structure, etc.). The sets 120, 122 and 124 each comprise several strands that each comprise a plurality of cables (for example, several thousand cables are grouped together per strand). The strands of cables or subsets of cables illustrated in FIG. 10 are referenced 120a-b for the set of cables 120, 122a-c for set 122 and 124a-b for set 124. These sets may include more strands of cables, but only these have been shown in order to avoid overloading the figures.

In each set of cables, all of the strands of cables are, for example, positioned parallel to one another and in a same plane.

FIG. 11 is a longitudinal sectional view in the vertical plane XZ of part of the structure 100 of FIG. 10 equipped with sets 120, 122 and 124.

As shown in FIGS. 10 and 11, the separate sets 120, 122 and 124 respectively extend in extension planes that are distributed along the height of the structure (axis Z). These planes could, however, protrude from the structure above, below and/or on the side thereof.

The respective extension planes P1, P2, P3 of the various sets 120, 122 and 124 are parallel to one another (these planes are parallel to the plane XY) and are situated at different altitudes from one another, as shown in FIG. 11: the set of cables 120 is situated at a higher altitude (along the axis Z) than that of the set of cables 122, which, in turn, is situated at a higher altitude than that of the set of cables 124. The planes are generally positioned in the median plane of the cable strands.

As shown in FIGS. 10 and 11, the separate sets 120, 122, 124 are positioned so as to intersect one another, alternating from one set to the immediately adjacent set.

Thus, for example, the cables of the set 120 extend along the axis X, while the cables of the set 122 situated immediately below extend along the axis Y and the cables of the set 124 situated immediately below the set 122 extend along the axis X.

In general, in a configuration that comprises at least two sets of cables, at least one set of cables is positioned parallel to the crosspieces and at least one set of cables is positioned parallel to the rails.

In the present case, two sets of cables, namely 120 and 124, are positioned parallel to the rails 114 and a third set of cables, namely 122, is positioned parallel to the crosspieces 112.

In general, in a configuration that comprises at least two sets of cables, at least one set of cables is positioned parallel to the crosspieces and at least one set of cables is positioned parallel to the rails. The at least one set of cables that is positioned parallel to the rails is fastened to the crosspieces, while the at least one set of cables that is positioned parallel to the crosspieces is fastened to the longitudinal elements.

In the present case, two sets of cables, namely 120 and 124, are fastened to the crosspieces 112 and a third set of cables, namely 122, is fastened to the rails 114.

In the present embodiment, each crosspiece 112 (FIG. 10) comprises a lower soleplate 112a and an upper soleplate 112b. Each crosspiece 112 is further provided at each of these soleplates with at least one fastening support 126a for the lower soleplate 112a, and at least one fastening support 126b for the upper soleplate 112b. The fastening support 126a, 126b is, for example, removable and attaches directly to the corresponding soleplate of the crosspiece (the support thus forms a vertical overthickness relative to the crosspiece on bottom and on top in FIG. 10) without requiring piercing, and therefore without damaging the crosspiece. The fastening support 126a, 126b is used to fasten one or several strands of cables of a set of cables that extends parallel to the rails 114. The support, known in itself, has a part forming an open housing in which the strand can be inserted forcibly (quickly and safely) so as to be solidly kept at the bottom of the housing and no longer be able to move relative to the latter.

Each bottom (126a) and top (126b) support can thus accommodate one or several strands of cables of the considered set of cables according to the support configuration. The support can, in fact, be elongated along the axis Y along the crosspiece 112 and include several parts spaced apart from one another along the axis Y and each forming a housing open to receive a strand. Alternatively, several bottom supports are positioned next to one another along the lower soleplate (like for the upper soleplate) in order each to accommodate a single cable.

As shown in FIG. 11, the bottom support 126a receives a strand of cables 124a of the set 124 and the top support 126b receives a strand of cables 120b of the set 120.

Each rail 114 is, in turn, provided, in its lower part, with at least one support 128 known in itself for fastening a set of cables that extends parallel to the crosspieces. Here, it is the set of cables 122 that is fastened to the rail 114 of FIG. 11. In the illustrated example, there is one cable support per strand. The supports 128 are spaced apart from one another along the axis X and each fastened below a rail 114. The supports 128 are positioned on either side of crosspieces that are themselves also fastened to the rails 114 from below.

Thus, each strand of each of the sets of cables is fastened either to several crosspieces 112 or to several rails 114. The crosspieces or the rails to which a same strand is fastened are not necessarily all of the crosspieces or all of the rails of the structure 100. For example, a strand that extends along the longitudinal axis X of the structure 100 can be fastened to only some of the crosspieces 112. The same is true with the rails 114 for a strand that extends along the longitudinal axis Y of the structure 100.

It will be noted that some strands of the sets of cables do not necessarily extend over the entire length (X) or width (Y) of the floor structure, depending on the pieces of aircraft equipment for which they are intended.

Such a floor structure 100 is thus pre-equipped with cables (pre-equipped floor) before it is inserted into the nose of an aircraft.

Furthermore, as shown in FIGS. 9 and 10, the floor structure 100 may comprise one or several intermediate brackets 118 for at least some of the crosspieces 112. The intermediate bracket(s) 118 are positioned below the crosspieces 112. In the illustrated embodiment, the crosspieces 112 of the floor are supported by several intermediate brackets 118 (with the exception, however, of the first one at the front end 100b of the floor, and which is much shorter than the others), and for example by two brackets 118. Each intermediate bracket 118 is for example a bracket connecting rod, which in turn will bear on the landing gear box of the nose.

It will be noted that the intermediate brackets can be omitted from the floor of FIG. 9.

We will now describe a method for integrating a floor as described above (pre-equipped or non-pre-equipped floor) into the nose of an aircraft according to one embodiment of the invention. The method, for example, uses an installation tooling 140. The tooling 140 is installed in the nose 30 of the aircraft to convey or transport the floor 100 toward its final installation location (operational position in which the floor performs its function(s) and which is illustrated in FIGS. 12 to 14 by reference E). This tooling is temporary, for the time needed to install the floor 100 previously formed from crosspieces and rails and which may or may not be equipped with several separate sets of cables and/or other system circuits (e.g., oxygen conduits, etc.), for example as previously described.

As illustrated in FIG. 12, the tooling 140 is shown placed inside the nose 130 without the floor 100, for clarity reasons. The floor is, however, shown in FIG. 13, fastened to the tooling 140 and in the process of being installed in the nose 130.

In general, the tooling 140 comprises a set of upper beams 142 (for example, two) and a set of lower beams 146 (for example, two) connected to the upper beams by lifting elements 148 such as wires (hereinafter, the elements will be considered to be wires, but the description applies to any element playing the same role). The upper beams, for example on the one hand, are rectilinear over a first non-curved part 142a of their length, and on the other hand, are curved downward over a second part 142b of their length. These forms allow the beams to adapt to the inner profile of the nose during a movement from the rear toward the front of the nose and when the cross-section becomes smaller. The lifting elements 148 are, for example, each fixedly connected to a lower beam 146, by a first of their two opposite ends, and movably to an upper beam 142 situated above, by the second end of the element (for example, via a roller).

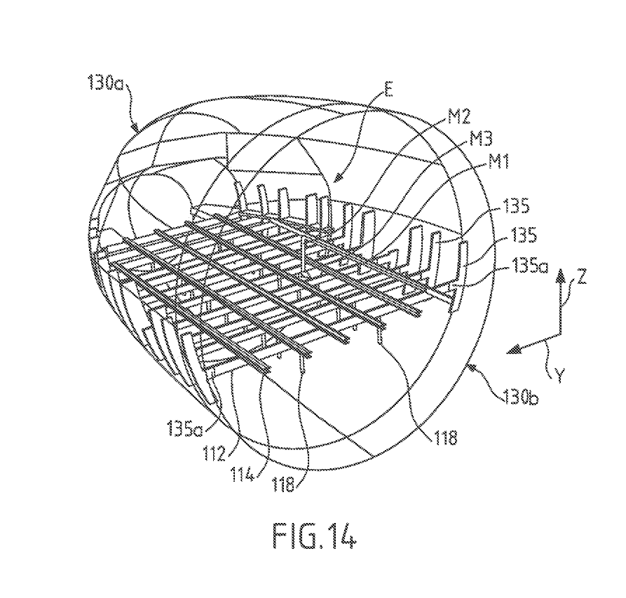

The method for installation the floor according to one embodiment of the invention can thus comprise the following steps for the prior placement of the tooling 140:
a step for securing the two upper beams 142 to the frames 135 of the structure 133 of the nose 130, at the ceiling 134 with quick fastening means 144 (FIG. 12);
a step for securing the two lower beams 146 on two rails 114 of the floor 100 (FIG. 13) in a known manner, the two lower beams 146 being fastened to the rails 114 when the floor 100 (the unified module) is outside the aircraft (FIGS. 9 to 11);
a step for insertion, along the longitudinal axis X, of the floor 100 fastened to the lower beams 146 in the nose, through the open rear end 130b of the nose, such that the lower beams 146 wind up parallel to the upper beams 142, each upper beam 142 being located at a lower beam 146;
a step for fastening lifting wires 148 to the lower beams 146 and the upper beams 142, each wire 148 connecting an upper beam 142 to the lower beam 146 situated at the upper beam; the fastening of each wire 148 at the upper beam 142 is done via at least one roller 150 (FIG. 12); this fastening step is intended to suspend the floor 100 from the two upper beams 142, since no support exists in the structure 133 of the aircraft able to support the floor; for example, mechanical separators, not shown, are positioned between the wires, in particular between the successive rollers, in order to maintain a controlled separation between the wires at the upper beam;
a drive step, in particular by actuating a drive system (not shown) to set the rollers 150 in motion along the upper beams 142 and move the floor 100 along the upper beams 142 via lifting wires 148 connected to the lower beams 146 secured to the floor;
a step for actuating a command and control system (not shown) to ensure optimized movement of the floor 100 along the upper beams 142, in particular with a readjustment of the length of each wire 148 at each moment of the movement of the floor 100 along the upper beams 142;
a step for moving the floor 100 toward the front end of the nose 130, this movement comprising a first horizontal component performed along non-curved parts 142a of the upper beams 142 at a constant altitude, followed by an oblique component along curved front parts 142b of the beams 142, allowing gradual lowering of the floor 100 in order to place it as precisely as possible in the nose 130, at the altitude of the lugs 135a of the frames 135 and in front of them (in FIGS. 13 and 14, the two lugs 135a of a frame are shown in the form of radial protuberances inside the frame and facing one another); during this movement, the floor has performed the combined movements M1 (longitudinal movement) and M2 (lowering) of FIG. 14;
a step for horizontal movement of the floor 100 backward (movement M3 of the trajectory of FIG. 14) at the altitude of the lugs 135a of the frames, this movement being obtained by commanding the movement of the rollers 150 backward, while elongating the length of the lifting wires 148 (owing to a length adjusting device 151 commanded on each wire illustrated in FIGS. 12 and 13), over a short distance to allow the docking of the ends of the crosspieces on the lugs of the frames (the floor is thus brought into its final operational position E in FIG. 14),
a step for complete fastening of the floor in this functional position in the nose 130 of the aircraft, the fastening of the floor being done by fastening the crosspieces to the frames, as already explained,
a step for removing the tooling 140 made up of the upper beams 142, the lower beams 146, the lifting wires 148, the drive system, the command and control system, once all of the operations to fasten the floor 100 in the nose have been performed.

After having fastened the crosspieces of the floor to the frames, the method may optionally include a step for placing diagonal elements, such as anti-crash (anti-accident) connecting rods. These diagonal elements are placed between two consecutive frames on the border of the floor. They serve to react the forces along the longitudinal axis X in case of crash or accident.

The tooling 140 described above in reference to FIGS. 12 to 14 for installing a pre-equipped or non-pre-equipped floor may include features other than those described in reference to these figures. The tooling 140 may, in particular, include certain other features of the tooling described in reference to FIGS. 1 to 8, or even all of the features of the latter.

The same tooling 140 can also be used to install a different module in the same zone of the aircraft, or even in a different zone.

The advantages and alternatives described in relation to the tooling of FIGS. 1 to 8 also apply to the tooling 140.

The tooling 140 that includes upper beams each having a curved or bent part can also be used to install a module in the tail of an aircraft.

It will be noted that the tooling according to one example embodiment may comprise a number of lift elements that is suitable for mechanically stiffening the module when it is fastened to the tooling. This number is, for example, greater than four. It is thus possible, by choosing a suitable number of lift elements, to manage the mechanical strength of the module (flexibility, rigidity) to allow it to be conveyed without deforming it and risking damaging it. To that end, it is necessary to know the natural rigidity or flexibility of the module before its integration (isolated module) and to dimension the necessary number of lift elements and their positioning on the module so that it is held at multiple points and it adopts the desired position when it is fastened to the tooling. It is thus maintained during its conveyance without deforming mechanically, even if its natural rigidity is insufficient to transport it in one piece.

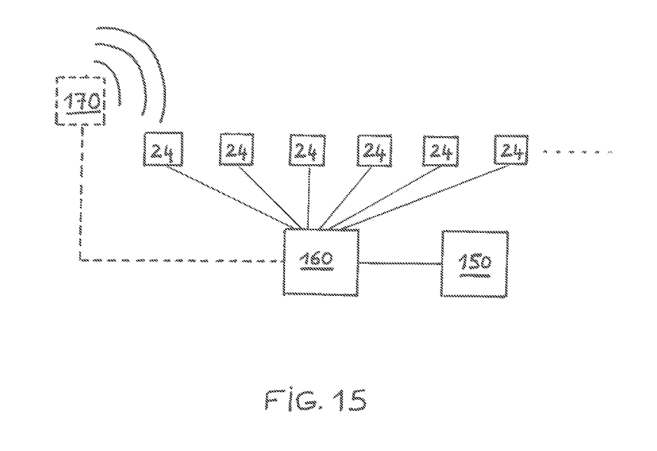

One possible system for controlling the length of the lift elements is illustrated in FIG. 15.

The system comprises a computer 150 and a command and control device 160 making it possible to control, in real time and in synchronization, all of the devices 24 for adjusting the length of the lift elements, not shown here for simplification reasons. A larger number of devices 24 can be provided, as illustrated by the dotted lines. The device 160 can be according to the above description. The device 160, for example, works in a programmed manner. The computer 150 is associated with memory resources, not shown (for example integrated in the computer) comprising encoded instructions that are readable by the processor of the computer and executable by the latter in order to command the operation of the device 160. The device 160 can be connected to the devices 24, for example by a wired connection, or communicate remotely with these devices. The devices 24 may or may not be controlled remotely and may or may not be controlled automatically.

In the same figure, another possible system [is shown] for controlling the length of the lift elements, taking into account the environment inside the aircraft. This other system copies the system of FIG. 15A and adds an obstacle detection system 170 thereto, shown in dotted lines, which, for example, works like a radar or by ultrasound, monitoring the environment inside the aircraft and in which the tooling moves with its attached module. The system 170 detects any obstacles and provides this information to the device 160 (by wired connection or remotely), which is thus able to adjust the spatial orientation of the module by controlling the length of the lift elements appropriately. It will be noted that the device 170 can be used for automatic piloting of the devices 24.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-25. (canceled)

26. Tooling for installing a module in a structure of an aircraft, comprising:
at least two lower beams configured to be secured to the module,
at least two upper beams configured to be secured to the structure of the aircraft,
lift elements connecting the upper beams to the lower beams, each lift element having a variable length and being provided with an adjustment device specific to its length.

27. The tooling according to claim 26, wherein each lift element is movably connected to an upper beam so as to be able to move freely along said upper beam, and is fixedly connected to a lower beam.

28. The tooling according to claim 26, further comprising a drive system configured to move the lift elements along the upper beams.

29. The tooling according to claim 26, wherein the two upper beams are parallel and extend along a longitudinal axis that is a longitudinal axis of the aircraft when the tooling is fastened to the structure of the aircraft.

30. The tooling according to claim 26, wherein the two upper beams each have a profile that is configured to adapt to a profile of an upper and inner zone of the structure of the aircraft.

31. The tooling according to claim 26, wherein the two upper beams are each rectilinear over a first part and curved over a second part.

32. The tooling according to claim 26, wherein the two lower beams are parallel to one another and are parallel to the upper beams, and wherein each upper beam is placed aligned with a lower beam.

33. The tooling according to claim 32, wherein each lift element is vertical and connects an upper beam to the lower beam that is aligned with said upper beam.

34. The tooling according to claim 26, wherein the two lower beams are configured to be fastened to the module with fasteners.

35. The tooling according to claim 34, wherein each connection between a lower beam and the module allows said beam to rotate around its longitudinal axis.

36. The tooling according to claim 26, wherein the two upper beams are intended to be fastened to frames of the structure of the aircraft with fasteners.

37. The tooling according to claim 36, wherein each connection between the upper beam and the frames allows a rotation of said beam around its longitudinal axis.

38. The tooling according to claim 26, wherein each lift element is connected to at least one roller mounted on the upper beam and is configured to roll along said beam.

39. The tooling according to claim 26, wherein the device for adjusting the length of each lift element is provided by a slaved electrical screw/nut system.

40. The tooling according to claim 26, further comprising a command and control device making it possible to control, in real time and in synchronization, all of said devices for adjusting the length of the lift elements.

41. The tooling according to claim 40, wherein the command and control device is configured to cause the module to undergo at least one movement to be chosen from among a rotation around a longitudinal axis of the aircraft, a rotation around a transverse axis of the aircraft and a translational movement along a vertical axis.

42. The tooling according to claim 26, wherein two successive lift elements along a same upper beam are separated by mechanical means ensuring a constant distance between said two elements at said upper beam.

43. The tooling according to 28, wherein the two upper beams are parallel and extend along a longitudinal axis that is a longitudinal axis of the aircraft when the tooling is fastened to the structure of the aircraft and wherein the drive system is produced by two traction ropes driven by an electric winding/unwinding device, and wherein said ropes cooperate with an upper end of at least one lift element.

44. The tooling according to claim 26, wherein the two lower beams are configured to stiffen the module.

45. The tooling according to claim 26, further comprising a system for detecting obstacles, and wherein the information provided by this detection system dictates the spatial orientation of the module, as well as the characteristics of the movement in the aircraft via the lift elements.

46. The tooling according to claim 26, further comprising shim stops secured to frames of the structure of the aircraft, and wherein said shim stops are configured to support the module at certain crosspieces of said module and therefore to freeze an altitude of the module in the aircraft.

47. The tooling according to claim 26, wherein each lift element is a wire.

48. The tooling according to claim 26, further comprising a number of lift elements that is suitable for mechanically stiffening the module when the module is fastened to the tooling.

49. An aircraft comprising a tooling for installing a module according to claim 26.

50. A method for integrating a module into an aircraft using a tooling according to claim 26, comprising the following steps:
securing two upper beams to an upper and inner zone of the structure of the aircraft,
securing two lower beams to the module,
inserting the module into the aircraft,
fastening the lift elements of the lower beams and the upper beams, such that each lift element connects an upper beam to a lower beam,
moving the module along the upper beams to convey the module to a specific receiving zone of the aircraft.
